(19) United States
(12) Patent Application Publication
(10) Pub. No.: US 2026/0302629 A1
(43) Pub. Date: Oct. 1, 2026

(54) FEEDING ASSEMBLY FOR A MATERIAL-EMBEDDED ANTENNA ASSEMBLY FOR A VEHICLE, ANTENNA SYSTEM, PANEL FOR A VEHICLE, AND VEHICLE

(71) Applicant: Volvo Car Corporation, Göteborg (SE)

(72) Inventors: Hanieh Aliakbariabar, Lund (SE); Christian Lötbäck, Falkenberg (SE); Buon Kiong Lau, Lund (SE); Xiaotian Li, Göteborg (SE)

(21) Appl. No.: 19/577,706

(22) Filed: Mar. 25, 2026

(30) Foreign Application Priority Data
Apr. 1, 2025 (EP) 25167615.1

(51) Int. Cl. H01Q 9/04; H01Q 1/32

(52) U.S. Cl. CPC H01Q 9/0457; H01Q 1/3275

(57) ABSTRACT

A feeding assembly for a material-embedded antenna assembly for a vehicle. The feeding assembly includes a first capacitive coupling interface for capacitively coupling to at least one antenna of the antenna assembly and a second capacitive coupling interface for capacitively coupling to at least one antenna of the antenna assembly. Moreover, the feeding assembly includes a first conductive path extending from the first capacitive coupling interface, a second conductive path extending from the second capacitive coupling interface, and a coplanar waveguide including an electrical signal line and two conductors forming an electric ground. The first conductive path and the second conductive path are electrically connected to the coplanar waveguide. Moreover, an antenna system including an antenna assembly and a feeding assembly are provided. Furthermore, a panel for a vehicle is presented. The panel includes a first material layer and a second material layer, and such an antenna system.

### CROSS-REFERENCE TO RELATED APPLICATION

The present disclosure claims the benefit of priority of co-pending European Patent Application No. 25167615.1, filed on Apr. 1, 2025, and entitled “FEEDING ASSEMBLY FOR A MATERIAL-EMBEDDED ANTENNA ASSEMBLY FOR A VEHICLE, ANTENNA SYSTEM, PANEL FOR A VEHICLE, AND VEHICLE,” the contents of which are incorporated in full by reference.

### TECHNICAL FIELD

The present disclosure relates to a feeding assembly for a material-embedded antenna assembly for a vehicle. Additionally, the present disclosure is directed to an antenna system including an antenna assembly with at least one antenna and a feeding assembly. The present disclosure also relates to a panel for a vehicle. The panel includes a first material layer, a second material layer, and an antenna system. Additionally, the present disclosure relates to a vehicle including a panel.

### BACKGROUND

Modern vehicles may be connected to wireless services such as AM/FM radio, Digital Audio Broadcasting (DAB), Global Navigation Satellite System (GNSS), Remote Keyless Entry (RKE), tire pressure monitoring system (TPMS), Electronic Toll Collection (ETC), cellular connectivity (Long Term Evolution (LTE), 4G, 5G), Bluetooth, Wi-Fi and V2X communication. Thereby, functionalities such as infotainment, access control, communication, positioning, and safety may be provided to a user of the vehicle.

For each of these services, one or more antennas are needed to transmit and/or receive the corresponding signals from or at the vehicle. Thus, a certain number of antennas may need to be fitted in a modern vehicle. In this context, it is known to provide at least some antennas in a module often called a “shark-fin”, i.e. a module including antennas which is arranged on a roof of the vehicle. Moreover, it is known to embed at least some antennas in a material, e.g. in a glass material or in a polymer material. Such antennas may be called material-embedded antennas. However, especially for the material-embedded antennas the communicative connection or electric connection of these antennas to the systems of the vehicle configured to use the antenna or interact with the antenna remains a challenge.

### SUMMARY

Consequently, it is an objective of the present disclosure to facilitate the communicative or electric connection of material-embedded antennas in vehicles. The problem is at least partially solved or alleviated by the subject matter of the present disclosure.

According to a first aspect, there is provided a feeding assembly for a material-embedded antenna assembly for a vehicle. The feeding assembly includes a first capacitive coupling interface for capacitively coupling the feeding assembly to at least one antenna of the antenna assembly and a second capacitive coupling interface for capacitively coupling the feeding assembly to at least one antenna of the antenna assembly. Moreover, the feeding assembly includes a first conductive path extending from the first capacitive coupling interface and a second conductive path extending from the second capacitive coupling interface. Furthermore, the feeding assembly includes a coplanar waveguide including an electrical signal line and two conductors forming an electric ground, where the electrical signal line is arranged between the two conductors forming the electric ground. The first conductive path and the second conductive path extend in parallel between the respective first capacitive coupling interface or second capacitive coupling interface and a connection zone. Additionally, the first conductive path and the second conductive path are electrically connected to the coplanar waveguide in the connection zone. Using the first capacitive coupling interface and the second capacitive coupling interface allows to communicatively connect the feeding assembly to the material-embedded antenna assembly without the need for a galvanic connection between the feeding assembly and the antenna assembly. This is advantageous for material-embedded antenna assemblies since the absence of a galvanic connection between the material-embedded antenna assembly and the feeding assembly allows to embed the antenna assembly in the material without any galvanic or conductor-bound connection to an outside of the material. This avoids the need to modify the material in order to electrically or communicatively connected the antenna assembly to the feeding assembly. Consequently, the antenna assembly may be encapsulated within the material. At the same time, the first capacitive coupling interface and the second capacitive coupling interface allow for a reliable electric or communicative connection of the antenna assembly to the feeding assembly. In an example, the first capacitive coupling interface and the second capacitive coupling interface are arranged on opposite sides of the antenna assembly. In case the antenna assembly includes a plurality of antennas, some of these antennas may be capacitively connected to the first capacitive coupling interface and the remaining ones of these antennas may be capacitively connected to the second capacitive coupling interface. Such a configuration is also advantageous from a packaging point of view. Coplanar waveguides are already known as such. In the fields of antenna assemblies for vehicles, coplanar waveguides are well-established and reliable solutions for communicatively or electrically connecting antenna systems. Thus, due to the fact that the feeding assembly of the present disclosure uses a coplanar waveguide, the feeding assembly of the present disclosure is compatible with known systems that need to be connected to an antenna assembly. The first capacitive coupling interface is electrically connected to the coplanar waveguide by the first conductive path. The second capacitive coupling interface is electrically connected to the coplanar waveguide by the second conductive path. Consequently, using the first conductive path and the second conductive path, an electric connection is established between the first capacitive coupling interface and the coplanar waveguide as well as between the second capacitive coupling interface and the coplanar waveguide. The first conductive path and the second conductive path may be formed as conductor traces, e.g. metallic conductor traces. According to an example, both the first conductive path and the second conductive path may be formed as so-called microstrip lines. In a situation in which the first conductive path and the second conductive path are embedded in a material, the first conductive path and the second conductive path may be designated as in-material, e.g. in-glass, microstrip lines. Consequently, a reliable electric connection is established between the first capacitive coupling interface, the second capacitive coupling interface and the coplanar waveguide. The fact that the first conductive path and the second conductive path extend in parallel allows to use both the first conductive path and the second conductive path are signal lines, where the signal may be 180 degrees phase-shifted. In such a configuration, the first conductive path and the second conductive path form a co-called balanced transmission line. Thus, the first conductive path and the second conductive path may form a so-called dual line, more precisely an in-material dual line. In case the material is glass, such a will line may be designated as in-glass dual line. Consequently, electric signals may be reliably fed into the antenna assembly capacitively coupled to the first capacitive coupling interface and to the second capacitive coupling interface. Additionally, radio signals received at the antenna assembly may be reliably transmitted to the coplanar waveguide via the first conductive path and the second conductive path. Altogether, the feeding assembly according to the present disclosure allows to reliably provide electric signals to a material-embedded antenna assembly. Similarly, the feeding assembly according to the present disclosure allows to reliably receive electric signals from a material-embedded antenna system. At the same time, the feeding assembly is structurally simple and compact.

It is noted that a feeding assembly according to the present disclosure may alternatively be called a feeding network.

It is further noted that in the context of the present disclosure, the term electrically connected covers at least a capacitive electric connection and a galvanic or direct electric connection.

It is additionally noted that the feeding assembly according to the present disclosure in principle may be electrically connected to any kind of an in-material antennas. Thus, the feeding assembly is independent from both a type of the in-material antenna and a type of material in which the in-material antenna assembly is embedded. Examples of materials in which the antenna assembly may be embedded include glass or polymer, e.g. polyvinyl butyral (PVB).

According to an example, the first conductive path is electrically connected to the signal line of the coplanar waveguide and the second conductive path is electrically connected to both conductors forming the electric ground of the coplanar waveguide. Such an electric connection is comparatively simple and reliable. Consequently, an electric signal may be transmitted in a reliable manner between the coplanar waveguide and the communication line formed by the first conductive path and the second conductive path. As has been mentioned before, an electric connection may be formed by a capacitive coupling or a galvanic or direct coupling. Thus, in the present example, the first conductive path may be capacitively coupled to the signal line of the coplanar waveguide or galvanically or directly connected to the signal line of the coplanar waveguide. Additionally or alternatively, the second conductive path may be capacitively coupled to the electric ground of the coplanar waveguide or galvanically or directly connected to the electric ground of the coplanar waveguide. According to a specific example, the first conductive path is galvanically or directly connected to the signal line of the coplanar waveguide while the second conductive path is capacitively coupled to the electric ground of the coplanar waveguide.

In an example, the second conductive path is electrically connected to both conductors forming the electric ground of the coplanar waveguide via two connection patches integrally formed at an end of the second conductive path. This means that the portions of the second conductive path which are connected to the electric ground of the coplanar waveguide are widened with respect to the remaining portions of the second conductive path. This facilitates in particular a capacitive coupling between the second conductive path and the electric ground of the coplanar waveguide. The fact that connection patches are used simplifies the connection of one single second conductive path to two separate conductors forming the electric ground of the coplanar waveguide. Altogether, a particularly reliable connection between the second conductive path and the electric ground of the coplanar waveguide may be achieved.

According to an example, the two connection patches integrally formed at the end of the second conductive path may have a generally triangular shape. This means that the connection patches are wider at their free ends than at their ends connected to the remaining portions of the second conductive path. Such connection patches may also be called stubs, more precisely radial stubs.

According to an example, the connection of the first conductive path and the signal line of the coplanar waveguide includes a tapering portion. The tapering portion may bridge different widths of the first conductive path and the signal line of the coplanar waveguide. In this context, the width of the first conductive path and the width of the signal line of the coplanar waveguide may have been chosen such that an electric functionality of the coplanar waveguide and the first conductive path is enhanced. The tapering portion allows for an efficient connection therebetween.

In an example, the first conductive path and/or the second conductive path includes at least two portions of different characteristic impedance. Using these two portions of different characteristic impedances allows to adapt the feeding assembly to a specific antenna system which is used in connection with the feeding assembly. More precisely, the characteristic impedance of the first conductive path and/or the second conductive path may be chosen as a function of a distance between the first conductive path and/or the second conductive path with respect to an element of the antenna assembly. For example, a characteristic impedance of the first conductive path and/or the second conductive path may be chosen to be lower in a portion of the first conductive path and/or the second conductive path which is arranged adjacent to an element of the antenna assembly, whereas a characteristic impedance of the first conductive path and/or the second conductive path may be chosen to be higher in a portion of the first conductive path and/or the second conductive path which extends over the element of the antenna assembly, i.e. which protrudes over the antenna assembly. Thereby, a radiation pattern of the first conductive path and/or the second conductive path may be designed such that it fits the radiation pattern of an antenna assembly to which the feeding assembly is connected.

In another example, the coplanar waveguide includes a bend. This means that an orientation of the direction of extension of the coplanar waveguide changes along a length of the coplanar waveguide. In an example, the bend may be a 180° bend. Such a bend facilitates an in-material embedding of at least a portion of the coplanar waveguide, whereas another portion of the coplanar waveguide needs to be accessible from an outside of this material in order to connect the feeding assembly to a system interacting with an antenna assembly via the feeding assembly. The latter portion, thus, is not embedded in the material. Moreover, such a bend may improve the performance of an antenna assembly connected to the feeding assembly.

According to an example, a connector is electrically connected to a free end of the coplanar wave guide. In this context, the free end of the coplanar waveguide is understood as the end of the coplanar waveguide which is arranged opposite the connection zone. As has been mentioned before, also the electric connection between the connector and the free end of the coplanar waveguide may be realized by capacitive coupling or by a galvanic or direct electric connection. Using the connector allows for a simple and reliable connection of the feeding assembly to a system configured to use an antenna assembly connectable to the feeding assembly via the first capacitive coupling interface and the second capacitive coupling interface.

According to a second aspect, there is provided an antenna system including an antenna assembly with at least one antenna and a feeding assembly according to the first aspect of the present disclosure. The first capacitive coupling interface of the feeding assembly is capacitively coupled to the antenna assembly. Moreover, the second capacitive coupling interface of the feeding assembly is capacitively coupled to the antenna assembly. Additionally, the antenna assembly is arranged between the first capacitive coupling interface and the second capacitive coupling interface. Thus, the antenna assembly which may be an in-material, e.g. in-glass, antenna assembly, may be reliably coupled to the feeding assembly. Consequently, electric signals may be reliably fed into the antenna assembly capacitively coupled to the first capacitive coupling interface and the second capacitive coupling interface. Additionally, radio signals received at the antenna assembly may be reliably transmitted to the coplanar waveguide via the first conductive path and the second conductive path. Altogether, the antenna system according to the present disclosure allows for a reliable communication using the antenna assembly. At the same time, the antenna system is structurally simple and compact.

In an example, a first portion of the first conductive path extends adjacent to the antenna assembly and a second portion of the first conductive path protrudes from the antenna assembly. Moreover, a first portion of the second conductive path extends adjacent to the antenna assembly and a second portion of the second conductive path protrudes from the antenna assembly. The portion of the antenna assembly arranged adjacent to the first portion of the first conductive path and the first portion of the second conductive path may be an electrical ground for the first portion of the first conductive path and the first portion of the second conductive path. Additionally or alternatively, both the second portion of the first conductive path and the second portion of the second conductive path are signal lines, where the signal may be 180 degrees phase-shifted. In such a configuration, the first conductive path and the second conductive path may form a co-called balanced transmission line. Consequently, electric signals may be reliably fed into the antenna assembly. Additionally, radio signals received at the antenna assembly may be reliably transmitted to the coplanar waveguide via the first conductive path and the second conductive path.

According to an example, the antenna system includes at least three tapered slot antennas. Each of the tapered slot antennas includes a plate-shaped conductor and a tapered slot extending in the plate-shaped conductor and extending along a slot direction, where all slot directions are substantially oriented towards a center point of the antenna assembly. All tapered slots taper towards the center point. The slot directions are distributed with respect to a circumference extending around the center point. In other words, the tapered slot antennas are arranged in a star-shape or in a flower-shape, where the wide ends of the slots represent the tips of the star-shape. In this context, the fact that the slot directions are substantially oriented towards a center point of the antenna assembly means that the slot directions are either oriented towards the center point of the antenna assembly or towards a location close to the center point, e.g. at a maximum distance of 0.03 times a largest wavelength of the bandwidth of the antenna assembly or at a maximum distance of 15 mm. While a single one of the tapered slot antennas has a so-called endfire radiation pattern, i.e. a unidirectional pattern where the major lobe occurs at one end, the antenna assembly, i.e. the combination of at least three of such tapered slot antennas, realizes a multidirectional or omnidirectional pattern. This is useful for an application in a vehicle since a position and orientation of the vehicle with respect to a sender or receiver remote from the vehicle usually varies during the use of the vehicle. At the same time, tapered slot antennas have wideband characteristics. This means that a tapered slot antenna may be operated with approximately or exactly the same operating characteristics over a very wide range of frequencies or wavelengths. These frequencies or wavelengths may be defined by an associated bandpass filter. Thus, the antenna assembly including at least three tapered slot antennas provides both a multi-directional or omni-directional radiation pattern and wideband characteristics. Additionally, single tapered slot antennas and assemblies of tapered slot antennas provide good impedance matching capabilities. This facilitates the integration of an antenna assembly into a vehicle from an electric perspective. This is especially the case if the antenna is to be integrated into a panel of the vehicle, where the panel may include glass material or polymer material. It is usually difficult to perform the impedance matching in relatively high permittivity environments such as glass. Stated otherwise, known antennas typically designed for operation in low-permittivity environments cannot provide good radiation performance in a high permittivity environment. This may result in comparatively low radiation efficiency and/or comparatively low gain. In contrast thereto, the antenna assembly according to the present disclosure may be well adapted to such environments such that a high radiation performance can be achieved. This may result in comparatively high radiation efficiency and/or the realization of an intended radiation pattern, e.g. high gain. At the same time, such an antenna assembly is compact in size. First of all, this applies to a direction perpendicular to a plane of the plate-shaped conductors. In other words, such an antenna assembly has a comparatively small height or is comparatively flat. This remains the case even if the antenna assembly is slightly curved or bent due to an integration in a slightly curved or bent panel of a vehicle, e.g. a roof portion or window portion of the vehicle. Moreover, the dimensions of the antenna assembly lying within a plane defined by the plate-shaped conductors are smaller than a wavelength at which the antenna assembly is operated. Among other things, this may be positively influenced by a high-permittivity environment, e.g. glass material. More precisely, the dimensions of the antenna assembly lying within a plane defined by the plate-shaped conductors is small as compared to a central wavelength and/or as compared to a largest wavelength at which the antenna assembly is operated. This offers the possibility to integrate such an antenna assembly into a vehicle in a manner that improves aerodynamics and/or aesthetics compared to known ways of integrating antenna assemblies, e.g. shark fins. Furthermore, such an antenna assembly is simple from a structural point of view. This also has the effect that the antenna assembly may be produced in a comparatively simple and efficient manner.

In an example, the slot directions are evenly distributed with respect to the circumference extending around the center point. In this context, evenly distributed means that an angular distance between each pair of neighboring slot directions is constant over the antenna assembly. In this case, the radiation pattern of the antenna assembly is particularly uniform.

According to an example, the antenna assembly is configured as a cellular antenna assembly. This means that the antenna assembly covers frequencies of 617 MHz to 5 GHz which corresponds to all sub-6 GHz cellular bands. Thus, a 155% fractional broad bandwidth is needed. In this context, the bandwidth defines the range of frequencies or wavelengths at which the antenna assembly may be operated with approximately or exactly the same operating characteristics. In this context, the operating characteristics may be described by one or more performance metrics. The operating characteristics are approximately or exactly the same if the one or more performance metrics are below or above a predefined threshold. Examples of performance metrics include radiation efficiency, directivity, e.g. 3 dB from a maximum, and reflection coefficient. The bandwidth may correspond to a passband of a bandpass filter forming part of the antenna assembly or being connectable to the antenna assembly.

It is noted that sometimes tapered slot antennas are also called Vivaldi antennas. In the following, both terms will be used as synonyms.

According to a third aspect, there is provided a panel for a vehicle. The panel includes a first material layer and a second material layer. Moreover, the panel includes an antenna system according to the second aspect of the present disclosure. The antenna assembly is arranged between the first material layer and the second material layer. The first conductive path and the first capacitive coupling interface are arranged on a surface of the first material layer which is opposite to the antenna assembly. The second conductive path and the second capacitive coupling interface are arranged on a surface of the second material layer which is opposite to the antenna assembly. It is noted that the first material layer and the second material layer have been described as separate material layers in order to make it clear that material is located on both sides of the antenna assembly, i.e. in order to make clear that the antenna assembly is embedded within the material of these two material layers. However, after the embedding of the antenna assembly, the first material layer and the second material layer may appear as one single, continuous material layer. In other words, once the antenna assembly is embedded between the first material layer and the second material layer, borders between the first material layer and the second material layer may not be visible anymore. As has been mentioned before, the first material layer and/or the second material layer may include a glass material or a polymer material, e.g. polyvinyl butyral (PVB). Thus, not only the antenna assembly is embedded in a panel according to the third aspect of the present disclosure, but also the first conductive path, the first capacitive coupling interface, the second conductive path and the second capacitive coupling interface are provided on the first material layer or the second material layer respectively, such that the panel according to the third aspect of the present disclosure may be regarded as a component having an integrated antenna assembly and having integrated thereon or therein the first conductive path, the first capacitive coupling interface, the second conductive path and the second capacitive coupling interface. Such a panel may form part of a vehicle. Consequently, such a panel allows to integrate an antenna assembly, associated conductive paths and associated capacitive coupling interfaces into a portion of the vehicle. This allows to provide the antenna and the associated conductive paths in a reliable and compact manner.

In an example, the coplanar waveguide is provided on the same surface as the first conductive path or on the same surface as the second conductive path. In such a configuration, the first conductive path may be directly or galvanically connected to the coplanar waveguide, if the coplanar waveguide is provided on the same surface as the first conductive path. In this case, the second conductive path may be capacitively coupled to the coplanar waveguide. In a case in which the coplanar waveguide is provided on the same surface as the second conductive path, the second conductive path may be directly or galvanically coupled to the coplanar waveguide. In this latter case, the first conductive path may be capacitively coupled to the coplanar waveguide. Thus, in both alternatives, a reliable electric connection between the coplanar waveguide and both the first conductive path and the second conductive path is realized. Moreover, also the coplanar waveguide is integrated in or on the first material layer and the second material layer.

According to an example, the coplanar waveguide exits the first material layer and the second material layer at an edge of the first material layer and the second material layer. In other words, the coplanar waveguide may stick out or protrude from the first material layer and the second material layer. Such a configuration facilitates a connection of the coplanar waveguide to a connector and/or a system configured to be coupled to the antenna assembly.

In an example, the panel further includes a cover layer covering the first conductive path and the first capacitive coupling interface or the second conductive path and the second capacitive coupling interface. In a case in which a coplanar waveguide is provided, also at least a portion of the coplanar waveguide may be covered by the cover layer. This of course depends on the surface on which the coplanar waveguide is provided. The cover layer further enhances the integration of the first conductive path or the second conductive path. Stated otherwise, by providing the cover layer, the first conductive path and the first capacitive coupling interface or the second conductive path and the second capacitive coupling interface is embedded between the cover layer and the first material layer or the second material layer. This enhances the fact that the panel is one single component having integrated therein, the antenna assembly and the associated feeding assembly. Moreover, the cover layer protects the first conductive path and the first capacitive coupling interface or the second conductive path and the second capacitive coupling interface from environmental effects.

According to a further example, two cover layers are provided, where a first cover layer thereof covers the first conductive path and the first capacitive coupling interface and a second cover layer thereof covers the second conductive path and the second capacitive coupling interface. In such a case, also at least a portion of the coplanar waveguide will be covered by one of the cover layers. The two cover layers additionally enhance the integration of the first conductive path and the first capacitive coupling interface and the second conductive path and the second capacitive coupling interface. Stated otherwise, by providing the cover layer, the first conductive path and the first capacitive coupling interface is embedded between the first cover layer and the first material layer. The second conductive path and the second capacitive coupling interface are embedded between the second cover layer and the second material layer. This enhances the fact that the panel is one single component having integrated therein, the antenna assembly and the associated feeding assembly. Moreover, the cover layers protect the first conductive path and the first capacitive coupling interface and the second conductive path and the second capacitive coupling interface from environmental effects. When integrated or implemented in a vehicle, one of the cover layers may be referred to as an inner cover layer, e.g. inner glass, and the other cover layer may be referred to as an outer cover layer, e.g. outer glass.

According to an example, the panel forms one or more of a roof portion or a window portion. Thus, the panel may form a portion having an integrated antenna assembly and an integrated feeding assembly. Alternatively, the panel may form a window portion, e.g. a side window portion or rear window portion, having an integrated antenna assembly and an integrated feeding assembly.

According to a fourth aspect, there is provided a vehicle including a panel according to the third aspect of the present disclosure, where the panel forms one or more of a roof portion or a window portion. Due to the fact that the antenna assembly and at least a portion of the feeding assembly is integrated or embedded in the panel, this also applies to the vehicle. This means that the antenna assembly and at least a portion of the feeding assembly is integrated or embedded in the vehicle. In such a configuration, the antenna assembly and the feeding assembly require comparatively little space within the vehicle. Moreover, the antenna assembly and the feeding assembly are integrated in a manner that these components are protected from undesired environmental influences.

It is noted that the feeding assembly, parts or portions of the feeding assembly, the antenna assembly, and/or parts or portions of the antenna assembly may be made from a transparent or translucent material or a mesh material. In this context, the transparency or translucency applies to the visible spectrum. In case a mesh material is used, a human being can look through the voids of the mesh. This allows to integrate the antenna assembly and/or the feeding assembly in the locations of a vehicle for which transparency or translucency is important or even required, e.g. in glass parts. Thus, the integration of such an antenna assembly and/or feeding assembly is subject to less restrictions as compared to non-transparent or non-translucent conductors. Consequently, the antenna assembly and/or feeding assembly may be integrated in a mechanically, electrically and aesthetically suitable place. Put otherwise, the flexibility of integration is increased.

Examples of at least partially transparent or translucent materials include graphene, Indium Tin Oxides (ITO), Aluminum Zinc Oxide (AZO), Fluorine-doped Tin Oxide (FTO), Gallium-doped Zinc Oxide (GZO), ITO/copper/ITO nanocomposite films, Indium Gallium Zinc Oxide (InGaZnO4), Zinc Oxide (ZnO), Silver-coated Polyester (AgHT-8 or AgHT-4), Silver nanowire (AgNW) or Copper nanowire (CuNW).

Moreover, it should be noted that the above examples may be combined with each other irrespective of the aspect involved.

These and other aspects of the present disclosure will become apparent from and elucidated with reference to the examples described hereinafter.

### BRIEF DESCRIPTION OF THE DRAWINGS

Examples of the disclosure will be described in the following with reference to the following drawings.

FIG. 1 shows a vehicle according to the present disclosure including a panel according to the present disclosure, where the panel forms a roof portion and where the panel includes an antenna system according to the present disclosure with an antenna assembly and a feeding assembly according to the present disclosure, where the vehicle is using a wireless service provided by a sender or receiver.

FIG. 2 shows the panel of the vehicle in a separate view along direction II in FIG. 1.

FIG. 3 shows a schematic, sectional view of the panel of FIG. 2 along plane III-III in FIG. 2.

FIG. 4 shows the antenna system of the vehicle of FIG. 1 in a separate, more detailed view, where the antenna system is shown in the same perspective as in FIG. 2 and where the coplanar waveguide is bent less than in reality in order to better illustrate the structure of the coplanar waveguide.

FIG. 5 shows a detail V of the antenna assembly of FIG. 4.

FIG. 6 shows the antenna assembly of the vehicle of FIG. 1 in a separate, exploded view.

### DETAILED DESCRIPTION

The figures are merely schematic representations and serve only to illustrate examples of the disclosure. Identical or equivalent elements are in principle provided with the same reference signs.

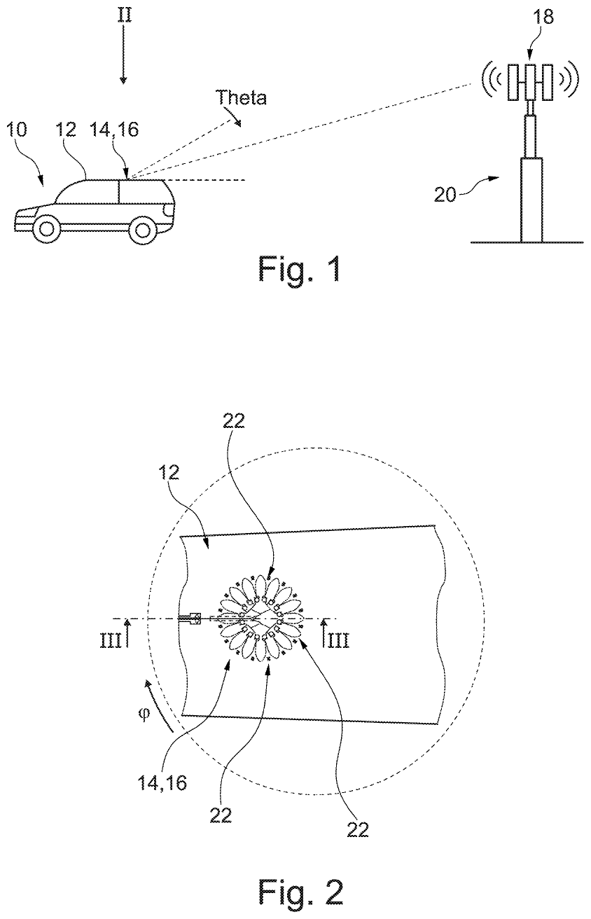

FIG. 1 shows a vehicle 10. The vehicle includes a panel 12 which in the present example forms a roof portion of the vehicle 10.

The panel 12 includes an antenna assembly 14 and an associated feeding assembly 16 which is capacitively coupled to the antenna assembly 14 as will be explained in more detail further below.

In the present example, the antenna assembly 14 is a cellular antenna assembly 14 covering all sub-6 GHz bands, e.g. LTE bands including low bands (617-960 MHz) or mid bands (1447.9-2170 MHz) or 5G bands (e.g. 2300-5 GHz). The antenna assembly 14 communicates with a stationary antenna 18 in a wireless manner. The antenna 18 can operate in a sending mode or a receiving mode. In the example shown in FIG. 1, the antenna 18 is mounted on a cell tower 20.

In this configuration, the main directions of arrival and departure of radio signals exchanged between the antenna assembly 14 and the antenna 18 are generally uniformly spread in azimuth φ, but cluster around an elevational angle theta in the range of 60 to 90 degrees (cf. FIGS. 1 and 2 in combination).

Therefore, the radiation pattern of the antenna assembly is omni-directional over the azimuth plane and across the theta angles of 60 to 90 degrees without any deep nulls throughout the frequency band.

In the following, the panel 12, the antenna assembly 14 and the feeding assembly 16 will be described in more detail with reference to FIGS. 2 to 6. In this context, the antenna assembly 14 may as well be designated as a radiator.

In the example shown in the Figures, the antenna assembly 14 includes a total of 16 tapered slot antennas 22.

These tapered slot antennas 22 use a common conductor 24 which is plate-shaped.

This conductor 24 and, thus, the antenna assembly 14 includes a center point 26.

Each of the tapered slot antennas 22 includes a tapered slot 28 extending along a slot direction 30. The borders of each tapered slot 28 follow an exponential function.

All slot directions 30 of all tapered slot antennas 22 are oriented towards the center point 26.

Moreover, all inner ends of all tapered slots 28 are located on a common circular circumference extending around the center point 26.

In the same manner, all outer ends of all tapered slots 28 are located on a common circular circumference extending around the center point 26.

Furthermore, all tapered slots 28 taper towards the center point 26.

Additionally, the slot directions 30 and, thus, all tapered slots 28 are evenly distributed with respect to a circumference extending around the center point 26.

This configuration results in a flower-shape or star-shape of the conductor 24.

Moreover, at the narrow end of each of the tapered slots 28, an elliptical resonant cavity 32 is provided. The elliptical resonant cavity 32 is formed as a through hole with an elliptical cross-section.

Furthermore, the tapered slots 28 are arranged in the common conductor 24 such that respective widest slot widths of neighboring tapered slot antennas 22 are directly adjacent to one another. This means that the tapered slots 28 are arranged such that it is geometrically not possible to move the slots 28 further towards the center point 26 without amending the geometry of the slots 28.

Due to the fact that all tapered slot antennas 22 use a common conductor 24, the plate-shaped conductors associated with each of the tapered slot antennas 22 are conductively coupled. In this context, each plate-shaped conductor associated with a single one of the tapered slot antennas 22 may be regarded as a circular sector of the common conductor 24 having the associated tapered slot 28 in its middle.

The antenna assembly 14 additionally includes a total of 16 groups of strip-shaped conductor elements. In the present example, each group includes 5 strip-shaped conductor elements.

In the examples shown in the Figures, the strip-shaped conductor elements and the common conductor 24 are made of a copper mesh material.

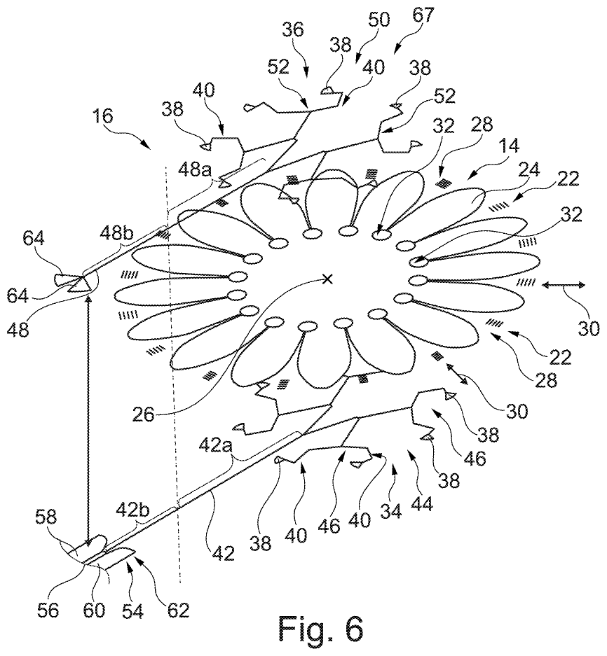

It is noted that for reasons of better visibility, only some of the tapered slot antennas 22, only some of the tapered slots 28, only some of the slot directions 30, and only some of the elliptical resonant cavities 32 are provided with a reference sign (see in particular FIGS. 4 and 6).

The feeding assembly 16 is used in order to provide a current to the antenna assembly 14 or in order to receive a current originating from the antenna assembly 14 following the reception of a radio signal. As has been mentioned before, the feeding assembly 16 is capacitively coupled to the antenna assembly 14.

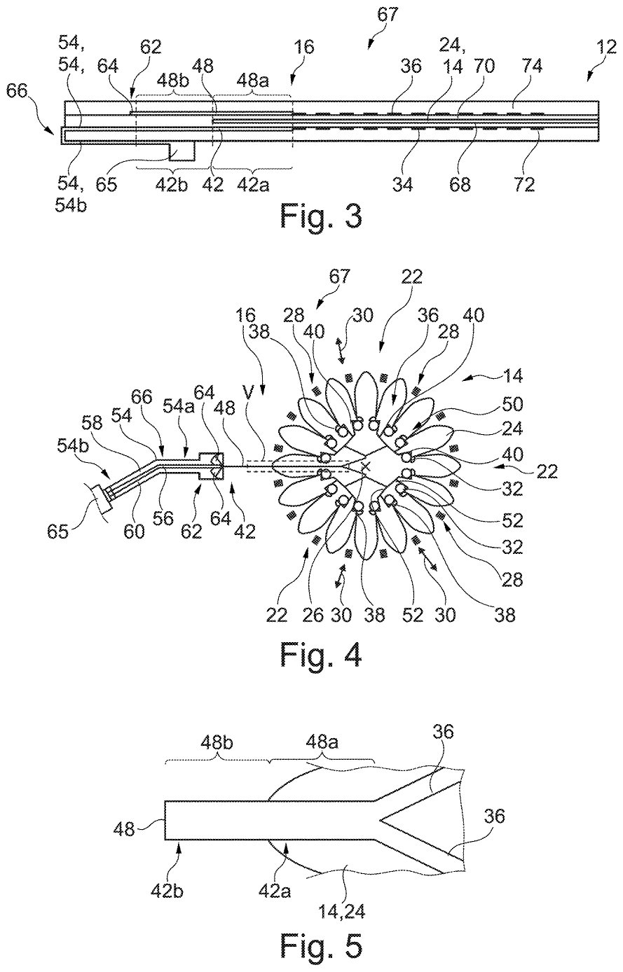

To this end, the feeding assembly 16 includes a first capacitive coupling interface 34 for capacitively coupling the feeding assembly 16 to eight out of the sixteen tapered slot antennas 22 of the antenna assembly 14 (cf. FIGS. 3, 4 and 6).

Moreover, the feeding assembly 16 includes a second capacitive coupling interface 36 for capacitively coupling the feeding assembly 16 to eight out of the tapered slot antennas of the antenna assembly 14.

More precisely, when considering the arrangement of the tapered slot antennas 22 along a circumference of the flower-shaped or star-shaped conductor 24, the first capacitive coupling interface 34 is capacitively coupled to every second tapered slot antenna 22 and the second capacitive coupling interface 36 is capacitively coupled to every other tapered slot antenna 22.

Moreover, in the present example, the first capacitive coupling interface 34 and the second capacitive coupling interface 36 are arranged on opposite sides of the antenna assembly 14. When considering the orientation of the panel 12 of the vehicle 10, the first capacitive coupling interface 34 is arranged on an inner side of the antenna assembly 14, i.e. on a side of the antenna assembly 14 oriented towards a passenger cabin of the vehicle 10, and the second capacitive coupling interface 36 is arranged on an outer side of the antenna assembly 14, i.e. on a side of the antenna assembly 14 oriented away from a passenger cabin of the vehicle 10.

Each of the first capacitive coupling interface 34 and the second capacitive coupling interface 36 includes a total of eight fan-shaped stubs 38. Each fan-shaped stub 38 is delimited by two straight edges meeting at their first respective ends and enclosing an angle of approximately 80°. The respective second ends of the straight edges are connected by a circular edge segment.

Each of the fan-shaped stubs 38 is associated with one of the tapered slot antennas 22 and is configured to generate a current in the associated tapered slot antenna 22 or to receive a current generated by the associated slot antenna 22 following the reception of a radio signal. As has been mentioned before, each of the fan-shaped stubs 38 is capacitively coupled to the associated tapered slot antenna 22. This means that each of the fan-shaped stubs 38 is offset from the antenna assembly 14, i.e. from the common conductor 24 along a direction perpendicular to a plane as defined by the common conductor 24. However, each of the fan-shaped stubs 38 is located opposite the associated slot antenna 22, more precisely, the corner of each fan-shaped stub 38 where the two straight edges meet is placed over a narrow end of the tapered slot 28 of the associated tapered slot antenna 22.

For the ease of representation, the fan-shaped stubs 38 of the first capacitive coupling interface 34 and the fan-shaped stubs 38 of the second capacitive coupling interface 36 are designated with the same reference sign.

Furthermore, the first capacitive coupling interface 34 and the second capacitive coupling interface 36 include a total of eight L-shaped conductor segments 40 respectively, where each of the L-shaped conductor segments 40 is connected to an associated fan-shaped stub 38 in an electrically conductive manner, i.e. galvanically. The L-shaped conductor segments 40 are arranged in the same plane as the fan-shaped stubs 38. Moreover, the L-shaped conductor segments 40 are arranged such that they go around the associated elliptical resonant cavity 32. As before, the L-shaped conductor segments 40 of the first capacitive coupling interface 34 and the second capacitive coupling interface 36 are designated with the same reference sign.

All fan-shaped stubs 38 of the first capacitive coupling interface 34 are fed using a first conductive path 42 extending from the first capacitive coupling interface 34 towards a radial outside of the antenna assembly 14.

In order to connect the fan-shaped stubs 38 of the first capacitive coupling interface 34 to the first conductive path 42, a network 44 of power dividers 46 is provided between the first conductive path 42 and each of the fan-shaped stubs 38. This network 44 of power dividers 46 also forms part of the first capacitive coupling interface 34.

Similarly, all fan-shaped stubs 38 of the second capacitive coupling interface 36 are fed using a second conductive path 48 extending from the second capacitive coupling interface 36 towards a radial outside of the antenna assembly 14.

In order to connect the fan-shaped stubs 38 of the second capacitive coupling interface 36 to the second conductive path 48, a network 50 of power dividers 52 is provided between the second conductive path 48 and each of the fan-shaped stubs 38. This network 50 of power dividers 52 also forms part of the second capacitive coupling interface 36.

In this context, each of the power dividers 46, 50 is Y-shaped in the sense that it includes a first terminal which may be an input terminal and which is located at the basis of the Y-shape and two second terminals which are located at respective upper ends of the Y-shape. The second terminals may be output terminals. This applies mutatis mutandis if the antenna assembly 14 operates in a receiving mode.

For reasons of better visibility, only some of the fan-shaped stubs 38, only some of the L-shaped conductor segments 40 and only some of the power dividers 46, 50 are provided with a reference sign.

In the example shown in the figures, the first conductive path 42 includes two portions. A first portion 42a of the first conductive path 42 extends adjacent to the antenna assembly 14. A second portion 42b of the first conductive path 42 protrudes from the antenna assembly 14. This means that in the perspective taken in FIGS. 2 and 4, the first portion 42a of the first conductive path 42 is arranged over or under the antenna assembly 14, where the second portion 42b of the first conductive path sticks out from the antenna assembly 14 (see also FIGS. 3 and 6).

In the present example, the first portion 42a and the second portion 42b of the first conductive path 42 have a different characteristic impedance. The characteristic impedance of the first portion 42a is lower, in the present example 25 ohms, than the characteristic impedance of the second portion 42b, in the present example 50 ohms.

The same applies to the second conductive path 48. This means, in the example shown in the figures, the second conductive path 48 includes two portions. A first portion 48a of the second conductive path 48 extends adjacent to the antenna assembly 14. A second portion 48b of the second conductive path 48 protrudes from the antenna assembly 14. This means that in the perspective taken in FIGS. 2 and 4, the first portion 48a of the second conductive path 42 is arranged over or under the antenna assembly 14, where the second portion 48b of the second conductive path 48 sticks out from the antenna assembly 14 (see also FIGS. 3 and 6).

In the present example, the first portion 48a and the second portion 48b of the second conductive path 48 have a different characteristic impedance. The characteristic impedance of the first portion 48a is lower, in the present example 25 ohms, than the characteristic impedance of the second portion 48b, in the present example 50 ohms (cf. FIG. 5).

The first conductive path 42 and the second conductive path 48 extended in parallel. This means that the first portion 42a of the first conductive path 42 and the first portion 48a of the second conductive path 48 extended in parallel. Moreover, the second portion 42b of the first conductive path 42 and the second portion 48b of the second conductive path 48 extended in parallel.

The feeding assembly 16 also includes a coplanar waveguide 54.

The coplanar waveguide 54 includes an electric signal line 56 and two conductors 58, 60 forming an electric ground. The electric signal line 56 is arranged between the two conductors 58, 60 forming the electric ground.

In a connection zone 62 of the feeding assembly 16, the first conductive path 42 and the second conductive path 48 are electrically connected to the coplanar waveguide 54.

In the present example, the coplanar waveguide 54 is arranged in the same plane as the first conductive path 42. The first conductive path 42 is galvanically or directly electrically connected to the signal line 56 of the coplanar waveguide 54. Since the electric signal line 56 and the first conductive path 42 have a different width, the electric connection is done via a tapering element.

The second conductive path 48 is capacitively coupled to both conductors 58, 60 forming the electric ground of the coplanar waveguide 54.

To this end, the second conductive path includes two connection patches 64 which are provided at a free end of the second conductive path 48, i.e. at the end of the second conductive path 48 which is arranged opposite to the second capacitive coupling interface 36. The connection patches 64 are integrally formed with the remaining portions of the second conductive path 48 (see FIGS. 4 and 6).

Each of the connection patches 64 is capacitively coupled to one of the conductors 58, 60 forming the electric ground of the coplanar waveguide 54.

The coplanar waveguide 54 includes a first portion 54a that extends along a substantially straight direction from the connection zone 62.

Moreover, the coplanar waveguide 54 includes a second portion 54b that extends along a substantially straight direction. The first portion 54a and the second portion 54b are coupled by a bend 66 of the coplanar waveguide 54 (cf. FIGS. 3 and 4). In the present example, the bend 66 is a 180° bend, such that the first portion 54a and the second portion 54b extends substantially in parallel.

At its free end, i.e. at the end of the second portion 54b of the coplanar waveguide 54 that is remote from the connection zone 62, a connector 65 is electrically connected to the coplanar waveguide 54.

It is noted that the combination of the antenna assembly 14 and the feeding assembly 16 may also be called an antenna system 67. In such an antenna system 67, the first capacitive coupling interface 34 of the feeding assembly 16 is capacitively coupled to the antenna assembly 14 and the second capacitive coupling interface 36 of the feeding assembly 16 is capacitively coupled to the antenna assembly 14, where additionally the antenna assembly 14 is arranged between the first capacitive coupling interface 34 and the second capacitive coupling interface 36.

In the present example, the antenna assembly 14 is a so-called material-embedded antenna assembly. This means that the antenna assembly 14 is embedded in a material from which the panel 12 is formed. Also a portion of the feeding assembly 16 is material-embedded.

In more detail, the panel 12 includes a first material layer 68 which may be made from polyvinyl butyral (PVB) and a second material layer 70 also made from polyvinyl butyral (PVB) (cf. FIG. 3).

The antenna assembly 14 may be arranged between the first material layer 68 and the second material layer 70.

It is noted that in a condition in which the antenna assembly 14 is arranged between the first material layer 68 and the second material layer 70, the first material layer 68 and the second material layer 70 may appear as one continuous material layer with the antenna assembly 14 embedded therein.

Moreover, the first capacitive coupling interface 34, the first conductive path 42, and the first portion 54a of the coplanar waveguide are arranged on a surface of the first material layer 68 which is opposite to the antenna assembly 14.

Furthermore, the first capacitive coupling interface 34, the first conductive path 42 and the first portion 54a of the coplanar waveguide 54 are covered by a first cover layer 72 which may be made from glass.

The second capacitive coupling interface 36 and the second conductive path 48 are arranged on a surface of the second material layer 70 which is opposite to the antenna assembly 14.

Furthermore, the second capacitive coupling interface 36 and the second conductive path 48 are covered by a second cover layer 74 which may be made from glass.

Thus, the panel 12 may be designated as a glass panel. Since in the present example, the panel 12 forms a portion of a roof, the panel 12 may as well be designated as a glass roof.

It is noted that the bend 66 and the second portion 54b of the coplanar waveguide 54b exit the first material layer 68 and the second material layer 70 at an edge thereof, such that the connector 65 may be comfortably connected to a system that uses the antenna (cf. FIG. 3).

Thus, when in use, a system of the vehicle may be communicatively connected to the antenna assembly 14 via the connector 65, the coplanar waveguide 54, the first conductive path 42, the second conductive path 48, the first capacitive coupling interface 34 and the second capacitive coupling interface 36. In order to allow for this communication, the coplanar waveguide 54 includes an electric signal line 56 and two electric conductors 58, 60 forming the electric ground, as has already been mentioned before. Moreover, as far as the first portion 42a of the first conductive path 42 and the first portion 48a of the second conductive path 48 are concerned, those are the portions of the first conductive path 42 and the second conductive path 48 which are arranged adjacent to the antenna assembly 14. Thus, in this zone, the antenna assembly 14 forms the electric ground for the first portion 42a of the first conductive path 42 and the first portion 48a of the second conductive path 48. The second portion 42b of the first conductive path 42 and the second portion 48b of the second conductive path 48 extend over the antenna assembly 14. In this zone, both the second portion 42b of the first conductive path 42 and the second portion 48b of the second conductive path 48 are signal lines, where the signal may be 180 degrees phase-shifted. In such a configuration, the first conductive path 42 and the second conductive path 48 may form a co-called balanced transmission line.

As used herein, the phrase “at least one,” in reference to a list of one or more entities should be understood to mean at least one entity selected from any one or more of the entities in the list of entities, but not necessarily including at least one of each and every entity specifically listed within the list of entities and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently “at least one of A and/or B”) may refer, in one example, to at least one, optionally including more than one, A, with no B present (and optionally including entities other than B); in another example, to at least one, optionally including more than one, B, with no A present (and optionally including entities other than A); in yet another example, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” and “A, B, and/or C” may mean A alone, B alone, C alone, A and B together, A and C together, B and C together, A, B, and C together, and optionally any of the above in combination with at least one other entity.

Other variations to the disclosed examples can be understood and effected by those skilled in the art in practicing the claimed disclosure, from the study of the drawings, the disclosure, and the appended claims. In the claims the word “comprising” does not exclude other elements or steps and the indefinite article “a” or “an” does not exclude a plurality. A single processor or other unit may fulfill the functions of several items or steps recited in the claims. The mere fact that certain measures are recited in mutually different dependent claims does not indicate that a combination of these measures cannot be used to advantage. A computer program may be stored/distributed on a suitable medium such as an optical storage medium or a solid-state medium supplied together with or as part of other hardware, but may also be distributed in other forms, such as via the Internet or other wired or wireless telecommunication systems. Any reference signs in the claims should not be construed as limiting the scope of the claims.

1. A feeding assembly for a material-embedded antenna assembly for a vehicle, the feeding assembly comprising:
a first capacitive coupling interface for capacitively coupling the feeding assembly to at least one antenna of the antenna assembly;
a second capacitive coupling interface for capacitively coupling the feeding assembly to at least one antenna of the antenna assembly;
a first conductive path extending from the first capacitive coupling interface;
a second conductive path extending from the second capacitive coupling interface; and
a coplanar waveguide comprising an electrical signal line and two conductors forming an electric ground, wherein the electrical signal line is arranged between the two conductors forming the electric ground;
wherein the first conductive path and the second conductive path extend in parallel between the respective first capacitive coupling interface or second capacitive coupling interface and a connection zone; and
wherein the first conductive path and the second conductive path are electrically connected to the coplanar waveguide in the connection zone.

2. The feeding assembly of claim 1, wherein the first conductive path is electrically connected to the signal line of the coplanar waveguide and the second conductive path is electrically connected to both conductors forming the electric ground of the coplanar waveguide.

3. The feeding assembly of claim 2, wherein the second conductive path is electrically connected to both conductors forming the electric ground of the coplanar waveguide via two connection patches integrally formed at an end of the second conductive path.

4. The feeding assembly of claim 2, wherein the connection of the first conductive path and the signal line of the coplanar waveguide comprises a tapering portion.

5. The feeding assembly of claim 1, wherein the first conductive path and/or the second conductive path comprises at least two portions of different characteristic impedance.

6. The feeding assembly of claim 1, wherein the coplanar waveguide comprises a bend.

7. The feeding assembly of claim 1, wherein a connector is electrically connected to a free end of the coplanar wave guide.

8. An antenna system, comprising:
an antenna assembly with at least one antenna; and
a feeding assembly, comprising:
a first capacitive coupling interface for capacitively coupling the feeding assembly to at least one antenna of the antenna assembly;
a second capacitive coupling interface for capacitively coupling the feeding assembly to at least one antenna of the antenna assembly;
a first conductive path extending from the first capacitive coupling interface;
a second conductive path extending from the second capacitive coupling interface; and
a coplanar waveguide comprising an electrical signal line and two conductors forming an electric ground, wherein the electrical signal line is arranged between the two conductors forming the electric ground;
wherein the first conductive path and the second conductive path extend in parallel between the respective first capacitive coupling interface or second capacitive coupling interface and a connection zone; and
wherein the first conductive path and the second conductive path are electrically connected to the coplanar waveguide in the connection zone;
wherein the first capacitive coupling interface of the feeding assembly is capacitively coupled to the antenna assembly;
wherein the second capacitive coupling interface of the feeding assembly is capacitively coupled to the antenna assembly; and
wherein the antenna assembly is arranged between the first capacitive coupling interface and the second capacitive coupling interface.

9. The antenna system of claim 8, wherein a first portion of the first conductive path extends adjacent to the antenna assembly and a second portion of the first conductive path protrudes from the antenna assembly, and wherein a first portion of the second conductive path extends adjacent to the antenna assembly and a second portion of the second conductive path protrudes from the antenna assembly, wherein the portion of the antenna assembly arranged adjacent to the first portion of the first conductive path and the first portion of the second conductive path is an electrical ground for the first portion of the first conductive path and the first portion of the second conductive path.

10. The antenna system of claim 8, comprising at least three tapered slot antennas, each of the tapered slot antennas comprising a plate-shaped conductor and a tapered slot extending in the plate-shaped conductor and extending along a slot direction, wherein all slot directions are substantially oriented towards a center point of the antenna assembly, wherein all tapered slots taper towards the center point, and wherein the slot directions are distributed with respect to a circumference extending around the center point.

11. A panel for a vehicle, the panel comprising:
a first material layer and a second material layer; and
an antenna system, comprising:
an antenna assembly with at least one antenna; and
a feeding assembly, comprising:
a first capacitive coupling interface for capacitively coupling the feeding assembly to at least one antenna of the antenna assembly;
a second capacitive coupling interface for capacitively coupling the feeding assembly to at least one antenna of the antenna assembly;
a first conductive path extending from the first capacitive coupling interface;
a second conductive path extending from the second capacitive coupling interface; and
a coplanar waveguide comprising an electrical signal line and two conductors forming an electric ground, wherein the electrical signal line is arranged between the two conductors forming the electric ground;
wherein the first conductive path and the second conductive path extend in parallel between the respective first capacitive coupling interface or second capacitive coupling interface and a connection zone; and
wherein the first conductive path and the second conductive path are electrically connected to the coplanar waveguide in the connection zone;
wherein the first capacitive coupling interface of the feeding assembly is capacitively coupled to the antenna assembly;
wherein the second capacitive coupling interface of the feeding assembly is capacitively coupled to the antenna assembly; and
wherein the antenna assembly is arranged between the first capacitive coupling interface and the second capacitive coupling interface;
wherein the antenna assembly is arranged between the first material layer and the second material layer;
wherein the first conductive path and the first capacitive coupling interface are arranged on a surface of the first material layer which is opposite to the antenna assembly; and
wherein the second conductive path and the second capacitive coupling interface are arranged on a surface of the second material layer which is opposite to the antenna assembly.

12. The panel of claim 11, wherein the coplanar waveguide is provided on the same surface as the first conductive path or on the same surface as the second conductive path.

13. The panel of claim 11, wherein the coplanar waveguide exits the first material layer and the second material layer at an edge of the first material layer and the second material layer.

14. The panel of claim 11, further comprising a cover layer covering the first conductive path and the first capacitive coupling interface or the second conductive path and the second capacitive coupling interface.

15. A vehicle comprising the panel of claim 11, wherein the panel forms one or more of a roof portion or a window portion.
